(19) United States
(12) Patent Application Publication
(10) Pub. No.: US 2026/0215554 A1
(43) Pub. Date: Jul. 30, 2026

(54) WEARABLE DEVICE

(71) Applicant: Beijing Zitiao Network Technology Co., Ltd., Beijing (CN)

(72) Inventor: Junhui CHEN, Beijing (CN)

(21) Appl. No.: 19/351,194

(22) Filed: Oct. 6, 2025

(30) Foreign Application Priority Data
Jan. 27, 2025 (CN) 202510128733.1

(51) Int. Cl. A44C 9/00; H04B 1/3827; H04R 1/02

(52) U.S. Cl. CPC A44C 9/0053; H04B 1/385; H04R 1/02

(57) ABSTRACT

The application relates to the technical field of wearable devices, in particular to a wearable device, comprising: a speaker assembly; a housing comprising a first housing and a second housing, an accommodating space being enclosed and formed between the first housing and the second housing; the first housing being opened and provided with an installation space communicating with the accommodating space and accommodating the speaker assembly; the second housing being opened and provided with a through hole communicating with the accommodating space and the external environment; the through hole directly facing the speaker assembly and constituting a rear cavity of the speaker assembly; and the through hole being configured to be sealed by the user's body when the wearable device is worn.

### CROSS-REFERENCE TO RELATED APPLICATION(S

This application claims priority to Chinese Application No. 202510128733.1 filed on January 27, 2025, the disclosure of which is incorporated herein by reference in its entity.

### FIELD

The present application relates to the technical field of wearable devices, and in particular to a wearable device.

### BACKGROUND

With the development of technology, the finger rings worn on users' fingers are constantly being designed to be intelligent. For example, components such as microphones, sensors, speakers and batteries are added. These components are electrically connected through the internal FPC, so that they can interact with users, such as sending and receiving voice, playing music and videos through mobile phones, etc., making this type of ring increasingly popular among users.

### SUMMARY

The present application provides a wearable device.

This application provides a wearable device, comprising:

a speaker assembly;

a housing, comprising a first housing and a second housing, an accommodating space being enclosed between the first housing and the second housing, the first housing being opened and provided with an installation space communicating with the accommodating space and accommodating the speaker assembly, and the second housing being opened and provided with a through hole communicating with the accommodating space and the external environment, the through hole directly facing the speaker assembly and constituting a rear cavity of the speaker assembly;

the through hole being configured to be sealed by a user's body when the wearable device is worn.

In some embodiments, the installation space is configured as a through hole communicating with the accommodating space and the external environment; or,

the installation space is configured as an installation groove with an opening communicated with the accommodating space, and the housing is opened and provided with a sound outlet hole communicated with the installation groove.

In some embodiments, the speaker assembly and the second housing are separated by a preset distance in an axial direction of the through hole, and the preset distance is greater than or equal to 0.

In some embodiments, in a direction perpendicular to the axis of the through hole, a cross-sectional area of the through hole is larger or less than a cross-sectional area of the installation space.

In some embodiments, edge of the through hole located outside the accommodating space is provided with an annular cushioning washer.

In some embodiments, a side of the second housing facing away from the accommodating space is provided with a waterproof and breathable membrane covering the through hole.

In some embodiments, the housing is configured as a ring-shaped structure having a wearable hole.

In some embodiments, the second housing is configured as an annular inner housing, the first housing includes a bottom plate and an enclosing plate arranged around the bottom plate, the bottom plate is opened and provided with a first communicating hole, and one axial end of the annular inner housing is connected to the bottom plate; and

the housing also includes a cover having a second communicating hole, the other axial end of the annular inner housing is connected to the cover, and the cover is connected to the enclosing plate, and a central hole of the annular inner housing constitutes the wearable hole.

In some embodiments, the first housing is configured as an annular outer housing, the second housing is configured as an annular inner housing, and the central hole of the annular inner housing constitutes the wearable hole;

the housing further includes two annular covers, which are respectively disposed on both sides of the annular inner housing in the axial direction of the annular inner housing, and are both connected between the annular inner housing and the annular outer housing.

In some embodiments, the wearable device is a finger ring, the housing has a wearable hole for a finger to extend into, and the through hole communicates with the wearable hole.

In some embodiments, the wearable device is a bracelet, the second housing has an arc-shaped wearable surface, and the through hole penetrates through the arc-shaped wearable surface.

In some embodiments, the housing has a wearable hole for a wrist to extend into, and the through hole communicates with the wearable hole; or

the bracelet further includes a strap connected to the first housing and/or the second housing, and the strap is configured to bind the housing to the wrist.

The technical scheme provided by the embodiments of the present application has the following advantages compared with the prior art:

the wearable device has a housing including a first housing and a second housing, wherein an accommodating space is enclosed and formed between the first housing and the second housing, the first housing is opened and provided with an installation space communicating with the accommodating space and accommodating a speaker assembly, the second housing is opened and provided with a through hole communicating with the accommodating space and the external environment, and the through hole constitutes a rear cavity of the speaker assembly, and is sealed by the user's body when the wearable device is worn, so that the thickness of the second housing can be used to constitute the rear cavity of the speaker assembly. Compared with the existing technology, there is no need to set a separate cavity on the first housing to install the speaker assembly and form the rear cavity of the speaker assembly, and the overall thickness of the housing in the speaker-setting area can be reduced, that is, the spacing between the first housing and the second housing in the area where the speaker assembly is set can be reduced, thereby improving the problem that the speaker-setting area of the housing is protruding or has a large size can be solved, and the user experience and aesthetics can be improved.

### BRIEF DESCRIPTION OF THE DRAWINGS

The accompanying drawings, which are incorporated in and constitute a part of this specification, illustrate embodiments consistent with the present application and, together with the description, serve to explain the principles of the present application.

In order to more clearly illustrate the embodiments of the present application or the technical solutions in the prior art, the following briefly introduces the drawings required for use in the embodiments or the description of the prior art. Obviously, for ordinary technicians in this field, other drawings can be obtained based on these drawings without any creative work.

FIG. 1 is a schematic structural diagram of a finger ring in the prior art;

FIG. 2 is a schematic diagram of the structure of a wearable device according to some embodiments of the present application;

FIG. 3 is a schematic cross-sectional view of the wearable device in FIG. 2;

FIG. 4 is a schematic diagram of the structure of a wearable device according to some embodiments of the present application;

FIG. 5 is a schematic cross-sectional view of the wearable device in FIG. 4.

Among them, 1’. Speaker; 2’. Outer housing; 3’. Inner housing; 10’. Rear cavity;

1. Speaker assembly;

2. Housing; 21. First housing; 22. Second housing; 221. Through hole; 23. Cover; 201. Wearable hole;

3. Cushioning washer;

4. Waterproof and breathable membrane;

5. Electrical assembly;

10. Accommodating space; 20. Rear cavity.

### DETAILED DESCRIPTION OF EMBODIMENTS

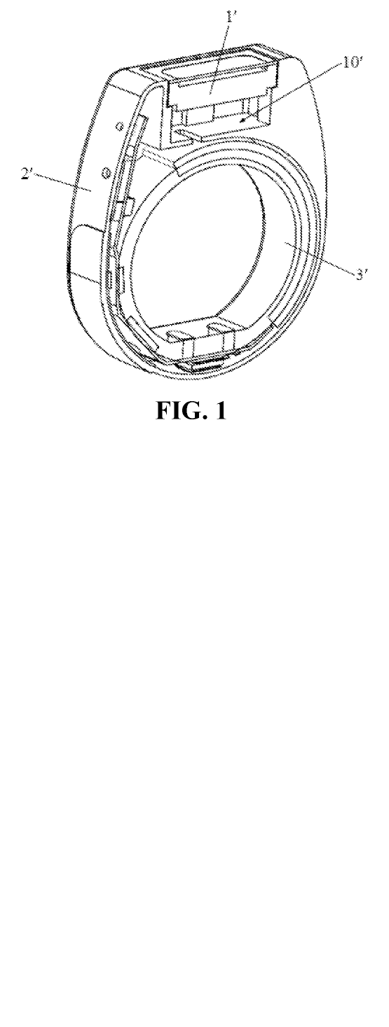

Currently, referring to FIG. 1, the housing of some finger rings typically consists of an outer housing 2’ and an inner housing 3’. An annular space, which forms installation components (such as a circuit board) between the outer housing 2’ and the inner housing 3’, is typically sealed with glue to seal the components. The finger rings contact the inner housing 3’ when they are worn. Among them, for finger rings with a speaker 1’, due to limited space, the speaker 1’ is disposed on the outer housing 2’. A cavity is separately provided on the outer housing 2’ corresponding to the speaker 1’ to install the speaker 1’, and a part of this cavity forms a rear cavity 10’ of the speaker 1’ to meet the operational requirements of the speaker 1’. This cavity is separated from the annular space, which makes the finger ring protrude more prominently in the local area where the speaker 1’ is disposed, resulting in poor aesthetics and a negative user experience.

In order to more clearly understand the above-mentioned objectives, features and advantages of the present application, the scheme of the present application will be further described below. It should be noted that, in the absence of conflict, the embodiments of the present application and the features therein can be combined with each other.

In the following description, many specific details are set forth to facilitate a full understanding of the present application, but the present application can also be implemented in other ways different from those described herein; it is obvious that the embodiments in the specification are only part of the embodiments of the present application, not all of the embodiments.

Referring to 2 to 3, an embodiment of the present application provides a wearable device, which includes a speaker assembly 1 and a housing 2. Among them, the housing 2 includes a first housing 21 and a second housing 22, and an accommodating space 10 is enclosed and formed between the first housing 21 and the second housing 22. The first housing 21 is opened and provided with an installation space communicating with the accommodating space 10 and accommodates the speaker assembly 1. The second housing 22 is opened and provided with a through hole 221 communicating with the accommodating space 10 and the external environment. The through hole 221 directly face the speaker assembly 1, and the through hole 221 constitutes the rear cavity 20 of the speaker assembly 1. The through hole 221 is configured to be sealed by the user's body when the wearable device is worn. The first housing 21 and the second housing 22 can be integrally formed or separately provided.

It should be noted that the above-mentioned through hole 221 can be set so that the cross-sectional area of the through hole 221 is less than the cross-sectional area of the installation space in the direction perpendicular to the axis of the through hole 221, or it can be set so that the cross-sectional area of the through hole 221 is equal to the cross-sectional area of the installation space, or it can be set so that the cross-sectional area of the through hole 221 is larger than the cross-sectional area of the installation space. That is, it can be selected according to actual needs and space, and if space permits, the larger the cross-sectional area of the through hole 221 is, the better, so that the volume of the rear cavity 20 of the speaker assembly 1 can be increased, thereby improving the sound quality of the speaker assembly 1.

Furthermore, the through hole 221 being sealed by the user's body when the wearable device is worn can be understood as being completely sealed by the user's body, or partially sealed by the user's body, that is, in this case, the through hole 221 is not completely sealed. Among them, the sound quality is best when the through hole 221 is completely sealed, while the sound quality is slightly reduced if it is not completely sealed.

Understandably, the housing 2 of the wearable device includes a first housing 21 and a second housing 22, and an accommodating space 10 is enclosed and formed between the first housing 21 and the second housing 22. The first housing 21 is opened and provided with an installation space communicating with the accommodating space 10 and accommodates the speaker assembly 1. The second housing 22 is opened and provided with a through hole 221, which communicates with the accommodating space 10 and the external environment, and the through hole 221 constitutes the rear cavity 20 of the speaker assembly 1, and is sealed by the user's body when the wearable device is worn. In this way, there is no need to set a cavity separated from the accommodating space 10 on the housing 2 to accommodate the speaker assembly 1 and form the rear cavity of the speaker assembly 1. Instead, the thickness of the second housing 22 is used to constitute the rear cavity 20 of the speaker assembly 1, which can reduce the spacing between the first housing 21 and the second housing 22 in the area where the speaker assembly 1 is set, improve the problem of the housing 2 protruding in the local area where the speaker assembly 1 is set, improve the aesthetics of the wearable device, and thus improve the user experience.

Furthermore, the wearable device further includes an electrical assembly 5, which is disposed within the accommodating space 10. The electrical assembly 5 includes multiple components, the specific types of which can be set according to the functions that the finger ring needs to implement. For example, the multiple components include a microphone, a battery, a motherboard, a Bluetooth module, etc. In this case, the wearable device can establish communication with a mobile phone via the Bluetooth module, enabling the user to make calls, send and receive voice messages, play music, and other functions through the wearable device.

In this case, the above-mentioned accommodating space 10 can be divided into a first space and a second space that are communicated with each other. The installation space and the through hole 221 are both communicated with the first space, in this case, the through hole 221 and the first space together constitute the rear cavity 20 of the speaker assembly 1, and the second space is used to accommodate the electrical assembly 5.

The wearable device can be a finger ring, in this case, the housing is an annular structure having a wearable hole 201 for a finger to extend into, and in which case the second housing contacts the finger when the wearable device is worn, so that the through hole can be sealed by the user's finger. It can also be a bracelet, and the bracelet can be an annular structure having a wearable hole 201 for a wrist to extend into, and the through hole can be sealed by the user's wrist when the wearable device is worn. Alternatively, it can be a bracelet with a strap, in which case the housing and the speaker assembly constitute the bracelet body of the bracelet, and the first housing and the second housing can be the upper housing and the lower housing respectively, with an installation space opened and provided on the upper housing and a through hole opened and provided on the lower housing. When the bracelet is worn, the lower housing contacts the user's wrist, so that the through hole can be sealed by the user's wrist.

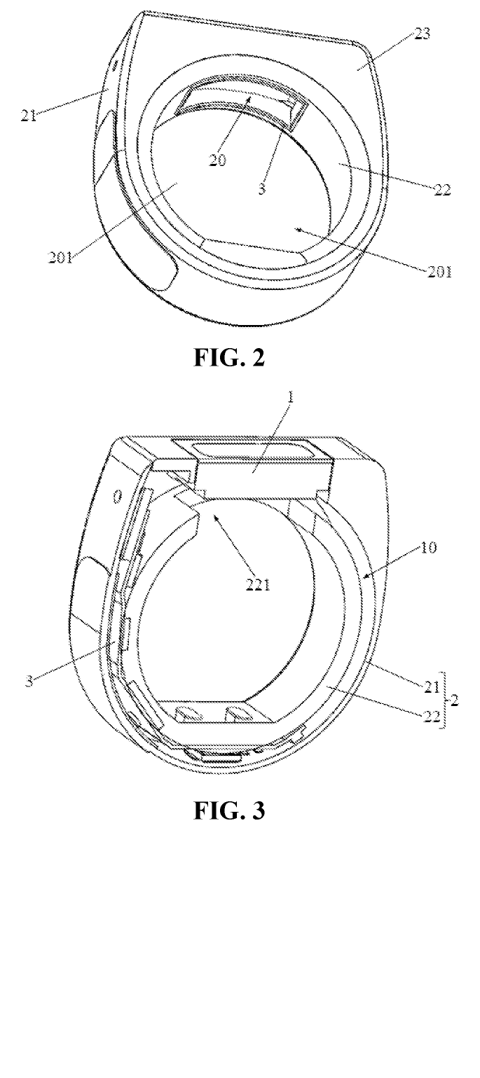

In some embodiments, referring to FIGS. 2 and 3, the installation space is configured as an installation through-hole communicating with the accommodating space 10 and the external environment. In this case, the above speaker assembly 1 is installed in the installation through-hole, and in which case the end of the through-hole communicating with the external environment can serve as a sound outlet hole for the speaker assembly 1.

Alternatively, in other embodiments, the installation space may be configured as an installation groove with an opening communicated with the accommodating space, with a sound outlet hole opened and provided in the housing and communicated with the installation groove. In this case, the location of the sound outlet hole can be adjusted based on actual needs, meaning the sound outlet hole can face any direction. Of course, the sound outlet hole may be located on the first housing 21, the second housing 22, or at the junction of the first and second housings 21, 22.

In some embodiments, the above speaker assembly 1 and the second housing 22 are separated by a preset distance in the axial direction of the through hole 221, and the preset distance is greater than or equal to 0.

Understandably, when the configuration of through hole 221, that is, the volume of through hole 221, is sufficient to serve as the rear cavity of speaker assembly 1, the aforementioned preset distance can be set to 0. In this case, if the cross-sectional area of through hole 221 is less than the cross-sectional area of the installation space in a direction perpendicular to the axis of through hole 221, speaker assembly 1 can be configured to abut against second housing 22, thereby improving the installation stability of speaker assembly 1. If the cross-sectional area of through hole 221 is equal to or larger than the cross-sectional area of the installation space, the end surface of speaker assembly 1 near second housing 22 is flush with the edge of second housing 22 near the end of speaker assembly 1.

Alternatively, the above-mentioned preset distance can also be set to be greater than 0. In this case, there is a gap between the speaker assembly 1 and the second housing 22 in the axial direction of the through hole 221, so that the area between the speaker assembly 1 and the second housing 22 together constitute the rear cavity of the speaker assembly 1. Of course, compared with Fig.1, the protrusion degree of the housing 2 at the position where the speaker assembly 1 is set is also reduced.

Optionally, in other embodiments, when the cross-sectional area of the through hole 221 is greater than the cross-sectional area of the installation space in a direction perpendicular to the axis of the through hole 221, the speaker assembly 1 may also partially extend into the through hole 221.

In some embodiments, referring to FIG. 2 and FIG. 3, an annular cushioning washer 3 is provided on the edge of the through hole 221 located outside the accommodating space 10.

That is, one end of the through hole 221 communicates with the accommodating space 10, and the other end communicates with the external environment. The cushioning washer 3 is disposed at the end of the through hole 221 communicated with the external environment. Thus, when the wearable device is worn, the cushioning washer 3 can act as a cushioning, preventing the edge of the through hole 221 from directly pressing the user's body and affecting wearing comfort. The cushioning washer 3 can be a silicone washer or a washer made of other materials such as rubber.

In addition, the cushioning washer 3 can be configured to be detachable, so that it can be replaced after a period of use to ensure a good cushioning effect, or the cushioning washer 3 can be replaced with a different color according to the user's personal preference to improve the aesthetics and meet the user's personalized needs. The detachable configuration method of the cushioning washer 3 can be bonding, clamping, etc. For example, if the cushioning washer 3 is configured for clamping, an annular clamping groove for accommodating the cushioning washer 3 can be provided on the second housing 22, and the cushioning washer can be clamped and placed in the annular clamping groove.

Optionally, in other embodiments, rounded corners may be provided on the outer edges of the through hole relative to the accommodating space to avoid forming sharp corners at the through hole, thereby improving the comfort of the user when wearing the wearable device.

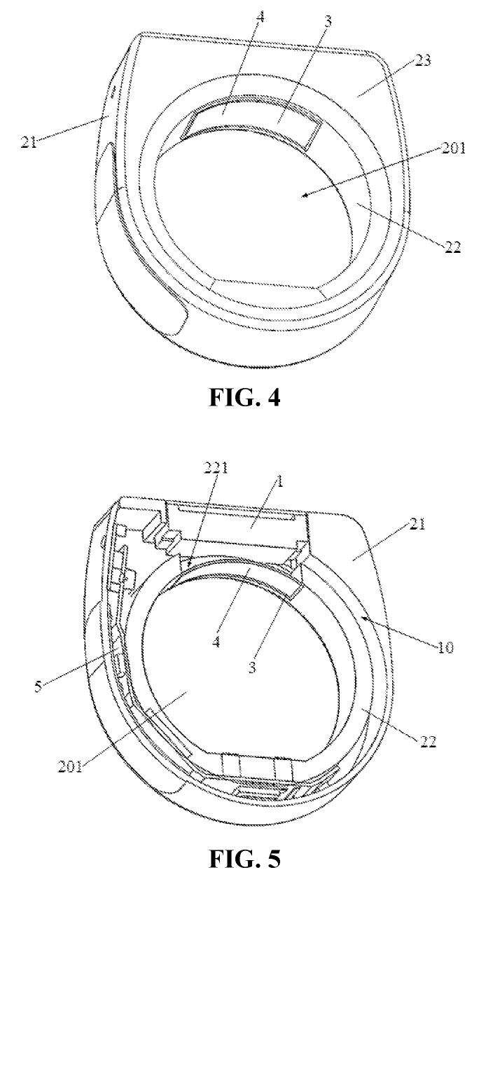

Further, referring to FIGS. 4 and 5, a waterproof and breathable membrane 4 covering the through-holes 221 is provided on the side of the second housing 22 facing away from the accommodating space 10. The waterproof and breathable membrane 4 is preferably made of expanded polytetrafluoroethylene (ePTFE), which has billions of micropores. This ensures reliable air permeability and balances pressure, providing reliable waterproof protection for the wearable device. Alternatively, the waterproof and breathable membrane 4 may be made of TPU film, PU film, or other materials.

It can be understood that by providing a waterproof and breathable membrane 4, it can achieve waterproof and dustproof effects, preventing external dust or foreign matter from entering the through hole 221 and the accommodating space 10, and can also prevent water or sweat from the user's body from entering the accommodating space 10, thereby ensuring the service life of the components in the accommodating space 10.

The cushioning washer 3 is disposed around the waterproof and breathable membrane 4 and can be configured to press against the waterproof and breathable membrane 4 to improve the stability of the waterproof and breathable membrane 4.

Furthermore, the waterproof and breathable membrane 4 may be detachable. For example, the waterproof and breathable membrane 4 is fixed to the second housing 22 by bonding. The user may detach the waterproof and breathable membrane 4 for replacement after using it for a period of time.

In some embodiments, the housing 2 is configured as a ring-shaped structure having a wearable hole 201. In this case, the wearable device can be a finger ring, a ring, or a bracelet.

For example, in one specific implementation, referring to FIGS. 4 and 5, the second housing 22 is configured as an annular inner housing. The first housing 21 includes a bottom plate and an enclosing plate disposed around the bottom plate. The bottom plate is provided with a first communicating hole, and one axial end of the annular inner housing is connected to the bottom plate. The first and second housings 21, 22 may be integrally formed or separately provided.

The housing 2 also includes a cover 23 having a second communicating hole. The other axial end of the annular inner housing is connected to the cover 23, which is in turn connected to the enclosing plate. The center hole of the annular inner housing constitutes the aforementioned wearable hole 201. In other words, the housing 2 is now composed of three parts: the annular inner housing, the second housing 22, and the cover 23. Accommodating space 10 is enclosed and formed between the annular inner housing and the bottom plate and enclosing plate of the second housing 22, and the cover 23 encloses the accommodating space 10. Thus, the center hole of the annular inner housing constitutes the wearable hole 201.

In this case, when the installation space is configured as an installation groove with an opening communicated with the accommodating space 10, a sound outlet hole that communicates with the installation groove may be provided on the bottom plate, the enclosing plate of the first housing 21 or the cover 23.

It should be noted that, at this time, one axial end of the annular inner housing can be extended into the first communicating hole and flush with the outer side surface of the bottom plate, and the other axial end of the annular inner housing can be extended into the second communicating hole and flush with the outer side surface of the cover 23. At this time, the center hole of the annular inner housing is the wearable hole 201, or the two axial ends of the annular inner housing may not be extended into or partially extend into the first communicating hole and the second communicating hole. At this time, the center hole of the annular inner housing, the first communicating hole and the second communicating hole constitute the wearable hole 201.

Taking the separate arrangement of the first housing 21 and the second housing 22 as an example, when assembling the wearable device, the first housing 21 and the second housing 22 can be assembled first, and then the electrical assembly 5 can be provided in the accommodating space 10, and then the cover 23 can be assembled to enclose the accommodating space 10, and the area where the electrical assembly 5 is set in the accommodating space 10 can be sealed with glue.

For example, the second housing 22 can be configured in a circular or approximately circular shape, which facilitates adapting to the user's fingers and improving wearing comfort. Alternatively, the second housing 22 can have an arc-shaped wearable surface, so that when the wearable device is worn, the arc-shaped wearable surface can fit the fingers, improving wearing comfort. In this case, the second housing 22 can also have other shapes, such as a square ring.

For example, in another specific implementation, the first housing is configured as an annular outer housing, and the second housing is configured as an annular inner housing, and the central hole of the annular inner housing constitutes the wearable hole 201. In this case, the housing may also include two annular covers, which are respectively disposed on both sides of the annular inner housing in the axial direction, and the two annular covers are connected between the annular inner housing and the annular outer housing. In other words, in this case, the housing is composed of an annular inner housing, an annular outer housing and two annular covers, and an annular accommodating space is formed between the annular inner housing and the annular outer housing, and the two annular covers respectively enclose the accommodating space on both sides of the annular inner housing in the axial direction, thus forming an annular structure with a wearable hole 201.

In this case, when the installation space is configured as an installation groove with an opening communicated with the accommodating space, a sound outlet hole that communicates with the installation groove may be opened and provided on the annular cover and/or the bottom plate of the first housing.

In some embodiments, referring to FIGS. 2 to 5, the wearable device may be a finger ring. In this case, the housing 2 has a wearable hole 201 for a finger to extend into, and the through hole 221 communicates with the wearable hole 201. Thus, when the finger ring is worn, it is fitted over the user's finger through the wearable hole 201, and the through hole 221 in the second housing 22 can be sealed by the user's finger.

Specifically, the above-mentioned second housing 22 can be configured as an annular inner housing, the center hole of the annular inner housing constitutes the above-mentioned wearable hole 201, the first housing 21 includes a bottom plate and an enclosing plate arranged around the bottom plate, a first communicating hole is opened on the bottom plate, and one axial end of the annular inner housing is connected to the bottom plate.

The housing 2 also includes a cover 23 having a second communicating hole. The other axial end of the annular inner housing is connected to the cover 23, which is in turn connected to the enclosure. The center hole of the annular inner housing constitutes the aforementioned insertion hole 201. In other words, the housing 2 is composed of the annular inner housing, the second housing 22, and the cover 23. The annular inner housing, the bottom plate of the second housing 22, and the enclosure define the accommodating space 10, which is enclosed by the cover 23.

It should be noted that, at this time, one axial end of the annular inner housing can be extended into the first communicating hole and flush with the outer side surface of the bottom plate, and the other axial end of the annular inner housing can be extended into the second communicating hole and flush with the outer side surface of the cover 23. At this time, the center hole of the annular inner housing is the wearable hole 201; or the two axial ends of the annular inner housing may not be extended into or partially extend into the first communicating hole and the second communicating hole. At this time, the center hole, the first communicating hole and the second communicating hole of the annular inner housing constitute the wearable hole 201.

Thus, when assembling the wearable device, the first and second housings 21 and 22 can be assembled first, followed by disposing the electrical assembly 5 in the accommodating space 10, and finally, the cover 23 can be assembled to seal the accommodating space 10. Furthermore, the area where the electrical assembly 5 are set can be sealed with glue. Of course, if the first housing 21 and second housing 22 are integrally formed, the assembly process of the first and second housings 21 and 22 can be omitted.

Optionally, in some embodiments, the above wearable device may be a bracelet. In this case, the second housing has an arc-shaped wearable surface, and the through hole penetrates through the arc-shaped wearable surface. Thus, when the wearable device is fitted over the user's wrist, the arc-shaped wearable surface can fit the user's wrist, allowing the through hole in the second housing to be sealed by the user's wrist and improving wearing comfort. Of course, the above second housing may also have a wearable surface, which fits the user's body surface when the wearable device is worn.

It should be noted that even if an arc-shaped wearable surface is provided on the second housing, the arc-shaped wearable surface is not able to fit the wrist of all users, but it is relatively fit, thereby relatively improving the wearing comfort of the bracelet.

It should be noted that when the above-mentioned wearable device is a bracelet, in one case, the above-mentioned housing has a main housing and an annular housing that are integrally formed or separately set. The annular housing is disposed inside the main housing, and an installation space is disposed on the main housing. The center hole of the annular housing constitutes the above-mentioned wearable hole 201.

Take, for example, a case where the main housing and annular housing are separately disposed. The main housing includes a bottom plate and an enclosing plate. The bottom plate is opened and provided with a first communicating hole, and one axial end of the annular housing is connected to the bottom plate. The housing also includes an annular cover, which is connected to the main housing and the annular housing to enclose and form an accommodating space. In other words, the housing is composed of three parts: the main housing, the annular housing, and the annular cover. The center hole of the annular housing constitutes the wearable hole 201.

In another embodiment, the bracelet may further include a strap connected to the first housing and/or the second housing, and the strap can bind the housing to the wrist. In other words, the bracelet is worn by the strap. For example, the first housing and the second housing constitute the bracelet body, the first housing is the upper housing, and the second housing is the lower housing. The lower housing has the above-mentioned arc-shaped wearable surface. When the bracelet is worn, the arc-shaped wearable surface of the lower housing fits the user's wrist. In this case, the lower housing is configured as an overall arc-shaped structure or other structures having only an arc-shaped wearable surface.

It should be noted that, in this document, relational terms such as "first" and "second" are used only to distinguish one entity or operation from another entity or operation, and do not necessarily require or imply any actual relationship or order between these entities or operations. Moreover, the terms "comprises," "comprising," or any other variations thereof are intended to cover non-exclusive inclusion, so that a process, method, article, or device comprising a series of elements includes not only those elements, but also other elements not explicitly listed, or elements inherent to such process, method, article, or device. In the absence of further limitations, an element defined by the phrase "comprising a..." does not exclude the presence of other identical elements in the process, method, article, or device comprising the element.

The foregoing description is intended only to provide specific embodiments of the present application, which will enable those skilled in the art to understand and implement the present application. Various modifications to these embodiments will be readily apparent to those skilled in the art, and the general principles defined herein may be implemented in other embodiments without departing from the spirit or scope of the present application. Therefore, the present application is not limited to the embodiments described herein, but is intended to be construed in the broadest manner consistent with the principles and novel features disclosed herein.

We claim:

1. A wearable device, comprising:
a speaker assembly (1);
a housing (2), comprising a first housing (21) and a second housing (22), an accommodating space (10) being enclosed and formed between the first housing (21) and the second housing (22), the first housing (21) being opened and provided with an installation space communicating with the accommodating space (10) and accommodating the speaker assembly (1), and the second housing (22) being opened and provided with a through hole (221) communicating with the accommodating space (10) and external environment, the through hole (221) directly facing the speaker assembly (1), and the through hole (221) constituting a rear cavity of the speaker assembly (1), and
the through hole (221) being configured to be sealed by a user's body when the wearable device is worn.

2. The wearable device according to claim 1, wherein the installation space is configured as an installation through hole that communicates the accommodating space (10) with the external environment; or
the installation space is configured as an installation groove with an opening communicated with the accommodating space (10), and the housing (2) is opened and provided with a sound outlet hole communicated with the installation groove.

3. The wearable device according to claim 1, wherein the speaker assembly (1) and the second housing (22) are separated by a preset distance in an axial direction of the through hole (221), and the preset distance is greater than or equal to 0.

4. The wearable device according to claim 1, wherein in a direction perpendicular to an axis of the through hole (221), cross-sectional area of the through hole (221) is greater than or less than cross-sectional area of the installation space.

5. The wearable device according to claim 1, wherein edge of the through hole (221) located outside the accommodating space (10) is provided with an annular cushioning washer (3).

6. The wearable device according to claim 5, wherein a side of the second housing (22) facing away from the accommodating space (10) is provided with a waterproof and breathable membrane (4) covering the through hole (221).

7. The wearable device according to claim 1, wherein the housing (2) is configured in an annular structure with a wearable hole (201).

8. The wearable device according to claim 7, wherein the second housing (22) is configured as an annular inner housing, and the first housing (21) comprises a bottom plate and an enclosing plate arranged around the bottom plate, the bottom plate is opened and provided with a first communicating hole, and one axial end of the annular inner housing is connected to the bottom plate; and
the housing (2) further comprises a cover (23) with a second communicating hole, the other axial end of the annular inner housing is connected to the cover (23), and the cover (23) is connected to the enclosing plate, and a central hole of the annular inner housing constitutes the wearable hole (201).

9. The wearable device according to claim 7, wherein the first housing (21) is configured as an annular outer housing, the second housing (22) is configured as an annular inner housing, and a central hole of the annular inner housing constitutes the wearable hole (201); and
the housing (2) further comprises two annular covers, the two annular covers are disposed on both sides of the annular inner housing in an axial direction of the annular inner housing, respectively, and the two annular covers are connected between the annular inner housing and the annular outer housing.

10. The wearable device according to claim 1, wherein the wearable device is a finger ring, the housing (2) has a wearable hole (201) for a finger to extend into, and the through hole (221) communicates with the wearable hole (201).

11. The wearable device according to claim 1, wherein the wearable device is a bracelet, the second housing (22) has an arc-shaped wearable surface, and the through hole (221) penetrates through the arc-shaped wearable surface.

12. The wearable device according to claim 11, wherein the housing (2) has a wearable hole (201) for a wrist to extend into, and the through hole (221) communicates with the wearable hole (201); or
the bracelet further comprises a strap connected to the first housing (21) and/or the second housing (22), and configured to bind the housing (2) to the wrist.

13. An electronic device for communication, comprising:
a speaker assembly (1);
a housing (2), comprising a first housing (21) and a second housing (22), wherein an accommodating space (10) is enclosed and formed between the first housing (21) and the second housing (22), the first housing (21) is opened and provided with an installation space communicating with the accommodating space (10) and accommodating the speaker assembly (1), and the second housing (22) is opened and provided with a through hole (221) communicating with the accommodating space (10) and external environment, the through hole (221) directly face the speaker assembly (1), and is configured to be sealed by a user's body when the wearable device is worn; and
an electrical assembly (5), comprising a plurality of components for communication and disposed with the accommodating space (10), wherein the accommodating space (10) is divided into a first space and a second space that are communicated with each other, the installation space and the through hole (221) are both communicated with the first space, the through hole (221) and the first space together constitute the rear cavity (20) of the speaker assembly (1), the second space is configured to accommodate the electrical assembly (5).

14. The electronic device according to claim 13, wherein the installation space is configured as an installation through hole that communicates the accommodating space (10) with the external environment; or
the installation space is configured as an installation groove with an opening communicated with the accommodating space (10), and the housing (2) is opened and provided with a sound outlet hole communicated with the installation groove.

15. The electronic device according to claim 13, wherein the speaker assembly (1) and the second housing (22) are separated by a preset distance in an axial direction of the through hole (221), and the preset distance is greater than or equal to 0.

16. The electronic device according to claim 13, wherein in a direction perpendicular to an axis of the through hole (221), cross-sectional area of the through hole (221) is greater than or less than cross-sectional area of the installation space.

17. The electronic device according to claim 13, wherein edge of the through hole (221) located outside the accommodating space (10) is provided with an annular cushioning washer (3).

18. The electronic device according to claim 17, wherein a side of the second housing (22) facing away from the accommodating space (10) is provided with a waterproof and breathable membrane (4) covering the through hole (221).

19. The electronic device according to claim 13, wherein the housing (2) is configured in an annular structure with a wearable hole (201).

20. The electronic device according to claim 19, wherein the second housing (22) is configured as an annular inner housing, and the first housing (21) comprises a bottom plate and an enclosing plate arranged around the bottom plate, the bottom plate is opened and provided with a first communicating hole, and one axial end of the annular inner housing is connected to the bottom plate; and
the housing (2) further comprises a cover (23) with a second communicating hole, the other axial end of the annular inner housing is connected to the cover (23), and the cover (23) is connected to the enclosing plate, and a central hole of the annular inner housing constitutes the wearable hole (201).
